(19) United States
(12) Patent Application Publication
(10) Pub. No.: US 2010/0077450 A1
(43) Pub. Date: Mar. 25, 2010

(54) PROVIDING SIMPLIFIED INTERNET ACCESS

(75) Inventors: Efim Hudis, Bellevue, WA (US); Anatoliy Panasyuk, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/236,515

(22) Filed: Sep. 24, 2008

(51) Int. Cl. G06F 21/00

(52) U.S. Cl. 726/3

(57) ABSTRACT

Aspects of the subject matter described herein relate to providing simplified network access. In aspects, a network access device that controls access to a network is configured to allow communications with a set of specified hosts regardless of whether the requesting user has paid for or authorized payment for the network usage. The user may communicate with such hosts without further configuration, providing payment or other information to the network access device, or the like. If the user attempts to access other hosts, the network access device ensures that the user is authorized (e.g., has paid for, belongs to a partner organization, etc.) before granting the access.

### BACKGROUND

When traveling, a computer user may desire to access information from the Internet or a corporate network accessible via the Internet. For example, at a hotel, the user may be able to access the Internet by paying the hotel for Internet usage. When attempting to access the Internet, the user may be presented with a screen that indicates charges and terms of use associated with Internet usage. A logon screen may also be presented that asks for user credentials and authorization to charge the Internet usage to the user. After the user has provided credentials and authorized the charges, the user may then be allowed to access various Internet sites.

As another example, at an airport, to access the Internet, the user may pay for Internet usage via a credit card, PayPal, BOZII, IPass, or some other payment service. When the user first attempts to access the Internet via a Web browser, the Web browser may be redirected to a server for authentication and payment. Entering payment or other information may cut into precious time a user has while at the airport.

There are various other places that may provide Internet access including restaurants, train stations, libraries, hospitals, coffee shops, bookstores, fuel stations, department stores, supermarkets, and the like. One way in which entities may provide Internet access in these environments is through federated authentication. Setting up trust relationships between an Internet access provider such as one of the ones indicated above and an entity that can authenticate the user and/or the user's device is an involved process that does not scale well. As a result, smaller businesses and entities may not have an efficient mechanism for recovering expenses associated with providing Internet access to roaming users while the users may be frustrated by the need to subscribe to multiple Internet access providers to ensure that the users have Internet access wherever they might be.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to providing simplified network access. In aspects, a network access device that controls access to a network is configured to allow communications with a set of specified hosts regardless of whether the requesting user has paid for or authorized payment for the network usage. The user may communicate with such hosts without further configuration, providing payment or other information to the network access device, or the like. If the user attempts to access other hosts, the network access device ensures that the user is authorized (e.g., has paid for, belongs to a partner organization, etc.) before granting the access.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The Phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIGS. 3-4 are flow diagrams that generally represent actions that may occur in accordance with aspects of the subject matter described herein; and

FIGS. 5-6 are block diagrams representing exemplary environments in which aspects of the subject matter described herein may be implemented.

### DETAILED DESCRIPTION

### Definition

As used herein, the term “includes” and its variants are to be read as open-ended terms that mean “includes, but is not limited to.” The term “or” is to be read as “and/or” unless the context clearly dictates otherwise. Other definitions, explicit and implicit, may be included below.

### Exemplary Operating Environment

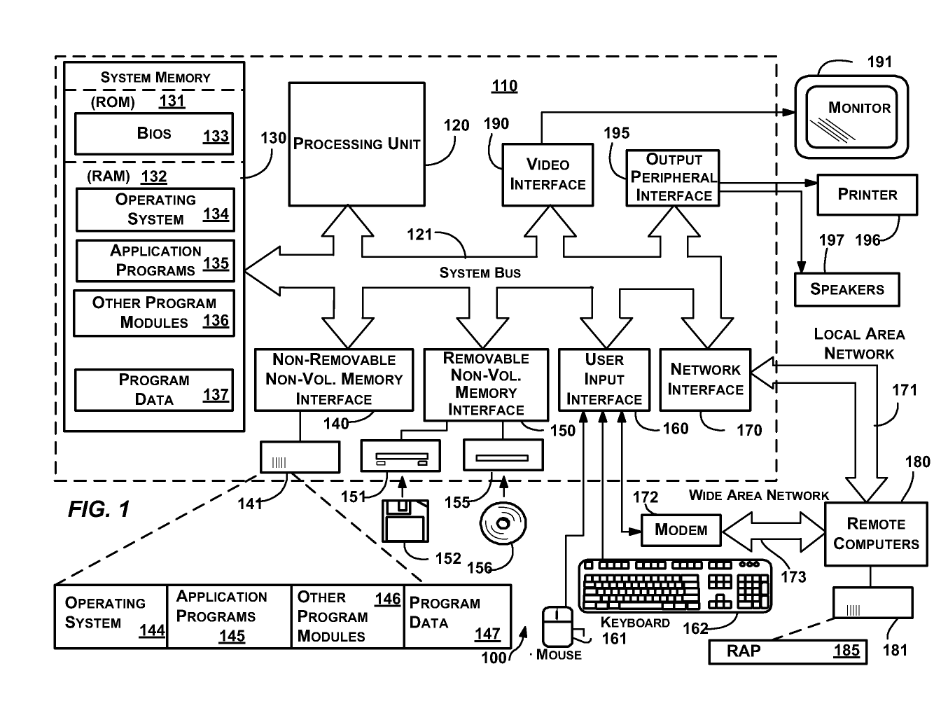

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus through a non-removable memory interface such as interface 140, and magnetic disk drive 151 and optical disc drive 155 are typically connected to the system bus by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Providing Internet Access

As mentioned previously, establishing a federated authentication system that allows a user to access the Internet from various locations while allowing the Internet access provider to charge for this service is an involved process that does not scale well when many entities are involved.

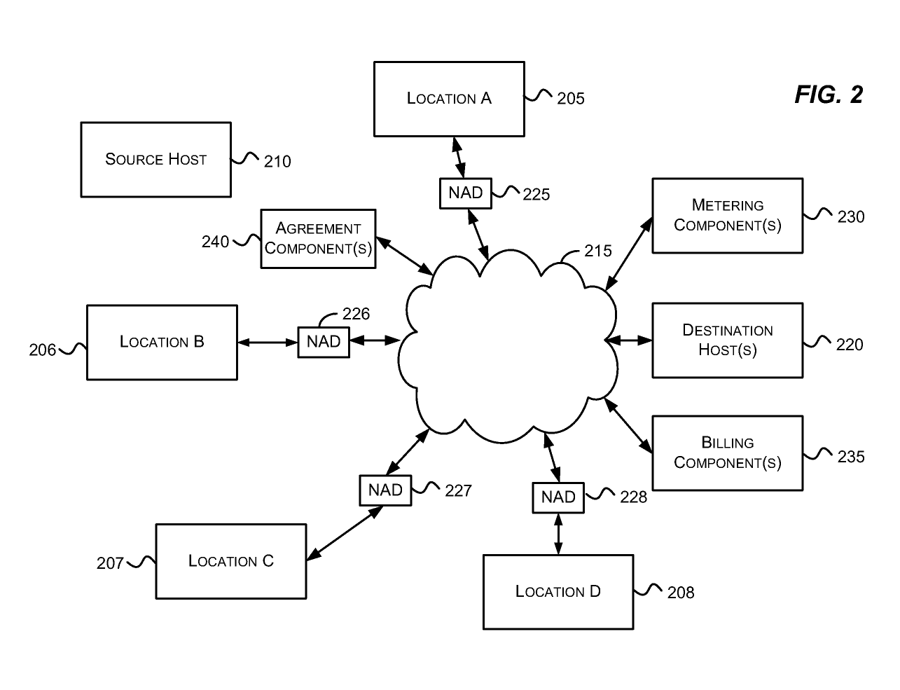

FIG. 2 is a block diagram representing an exemplary environment in which aspects of the subject matter described herein may be implemented. The environment may include various locations 205-208, a source host 210, destination host(s) 220, a network 215, network access devices 225-228, one or more metering components 230, one or more billing components 235, and one or more agreement components 240, and may include other entities (not shown).

The various entities may be located relatively close to each other or may be distributed across the world. The various entities may communicate with each other via various networks including intra- and inter-office networks and the network 215.

As used herein, the term component is to be read to include all or a portion of a device, one or more software components executing on one or more devices, some combination of one or more software components and one or more devices, and the like.

In an embodiment, the network 215 may comprise the Internet. In an embodiment, the network 215 may comprise one or more local area networks, wide area networks, wireless networks, direct connections, virtual connections, private networks, virtual private networks, some combination of the above, and the like. Wireless networks may include Wi-Fi, Bluetooth, Wireless Local Area Network (WLAN), Wireless Metropolitan area network (WMAN), Worldwide Interoperability for Microwave Access (WiMAX), cellular networks, and the like.

The hosts 210 and 220 may comprise one or more general or special purpose computing devices. Such devices may include, for example, personal computers, server computers, hand-held or laptop devices, multiprocessor systems, microcontroller-based systems, set top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as one or more of the hosts 210 or 220 comprises the computer 110 of FIG. 1.

Logically, the locations 205-208 are places at which a host may connect to the network 215. For example, a location may comprise a location at an enterprise network, a home, a hotel, a coffee shop, an Internet cafe, a public library, an airport, a cruise ship, a gas station, a restaurant, a grocery store, another type of hotspot, some other location, and the like.

Each of the locations 205-208 may be associated with one or more network access devices 225-228. A network access device may comprise one or more devices and/or software components configured to permit, deny, proxy, transmit, cache, meter, or perform other actions on computer traffic to and from the network 215. In one embodiment, a network access device may be a dedicated device such as a router or a gateway that provides access to the network 215. In another embodiment, a network access device may be a general purpose computer (e.g., computer 110 of FIG. 1) configured to provide access to the network 215. In some embodiments, a network access device may comprise components that reside on multiple devices.

In accordance with aspects of the subject matter described herein, a network access device may be configured to allow, without authentication or obtaining payment information from a user, any traffic to and from one or more hosts, uniform resource identifiers (URIs), IP addresses, domains, portions of domains, other network addresses or locations, and the like. Wherever the term “domain” is used herein, it is to be to be read alternatively one or more of the above. A domain may be associated with one or more URLs, such that when a network access device sees traffic directed to any of the URLs, the network access device may allow the traffic without first authenticating the user or user device or obtaining billing information from the user.

When a user attempts to access a host (e.g., one of the destination hosts 220) on such a domain, the user or user device may be authenticated by the destination host using any authentication method desired. A destination host may be associated with a domain such that the host handles requests sent to the domain. A destination host may provide various functionality including access to a corporate network, access to other resources such as other Web sites (e.g., via proxy through the service), and the like. Furthermore, for a domain, destination hosts may be geographically distributed through the network 215 such that the destination hosts for a domain are closer to the various locations 205-208. A particular destination host for a domain name may be determined by a Domain Name Service (DNS) server based on the location of requesting entity. This may be done to decrease latency, for example.

To meter and pay for network usage, many different types of mechanisms may be made. For example, in one embodiment, one or more metering components 230 may authenticate a user or the user's device and/or may measure usage of a domain. Measuring usage may involve measuring time that connections are open to the hosts in the domain, measuring how many users use hosts in the domain in a period of time (e.g., a day), measuring how much or what type of data is transmitted to and from hosts in the domain, other usage measuring, and the like. One or more billing components 235 may periodically send usage reports to a designated entity associated with the network access device to be used in charging for the usage.

In another embodiment, a network access device may include a metering component that measures the usage of hosts in the domain. In yet another embodiment, both the network access device and a host in the domain may include components that measure the usage of access to hosts in the domain. In one embodiment, the one or more metering components 230 may be distributed across the destination hosts 220, the network 215, and/or the network access devices 225-228.

Measurement data of usage of the network to access hosts in a domain may then be used to charge for the usage. Where the domain is associated with an organization, the organization may be billed for the usage. Where the domain provides services to subscribers, a business associated with the domain may be billed for the usage while the subscribers may be billed by the business using a variety of different billing models including a monthly or other periodic basis, on a per use basis, on a data transmitted basis, on another basis, and the like.

The billing methods described above are not meant to be all-inclusive or exhaustive. Indeed, based on the teachings herein, those skilled in the art may recognize other billing models that may benefit from the teachings herein without departing from the spirit or scope of aspects of the subject matter described herein.

When a network access device (e.g., one of the network access devices 225-228) receives a request to communicate with a host reachable via the network, the network access device may consult an agreement component (e.g., one of the agreement components 240). The agreement component 240 may determine whether the host is associated with an entity that has agreed to pay for providing access to the host. The agreement component 240 may reside on the network access device, may reside on another device, or may be distributed across multiple devices including or not including the network access device.

If the host is associated with an entity that has agreed to pay for providing access to the host, the network access device may grant the request regardless of whether the second entity has paid for or authorized payment for accessing the network. The phrase “regardless of whether the second entity has paid for or authorized payment for accessing the network” is not to be interpreted to mean that there are not other things (e.g., other than user payment) that the network access device may disregard when providing access. In other words, when the host is associated with an entity that has agreed to pay for providing access to the host, the network access device may grant the request without doing any additional checks or collecting any additional information from the user.

If the host is not associated with an entity that has agreed to pay for providing access to the host, the network access device may ensure that the user is authorized (e.g., has paid for or authorized payment) for access to the network before allowing the source host 210 to communicate with the destination host.

It will be recognized that the above mechanism provides a simplified way of providing access to a network without the difficulties of setting up trust relationships between an Internet access provider and an entity that can authenticate the user or the user device. Instead, an Internet access provider may simply add one or more domains to an access control list (ACL) of a network access device. When a device attempts to access a host on one of the domains, the device may be allowed to do so without further interaction from the Internet access provider. If a device attempts to access a host on a domain that is not on the ACL, the Internet access provider may behave in any way the provider sees fit including requesting payment or credentials from the user before allowing the access. Because establishing a trust relationship and various other security/payment mechanisms are not necessary under this model, the cost of providing Internet access may be reduced, while accessing the Internet may be made easier to an end user.

In addition, where the destination host is part of a corporate or other network that provides access to other resources, the security measures of the corporate network including malware scanning, anti-phishing measures, and other measures may be performed the traffic that passes through the destination host.

A company may act as a clearing house with multiple Internet access providers. In this role, the company may establish relationships with the access providers and may establish systems for updating lists of domains to which access is to be granted by the access providers. The company may allow other entities to subscribe to a service by which the other entities are able to indicate domains to which free access is to be granted to users. The company or the Internet access providers may measure usage of hosts on the domain. Information about usage by users of hosts on the domains may then be used to charge the entities for such usage. The company may pay the Internet access providers according to whatever agreements the company negotiates with the Internet access providers. The mechanism above may be used to reduce the complexity for the entities in providing free access to users to the hosts on their domains.

Using the teachings described herein, a company may promote one or more services. For example, a company may promote a search engine by entering into arrangements with Internet service providers (or a clearing house) to provide access to the domain associated with the search engine. A user using one of the Internet service providers can access the search engine without paying a fee or authentication whereas other search engines available at a location may involve paying a fee to obtain Internet access. The search engine provider may agree to pay the Internet service provider (or clearing house) a fee for each service or good sold via user interaction with the search engine.

Companies may use aspects of the subject matter described herein to provide “free” access to their services even from locations that typically charge a fee to access the Internet. In so doing a company may agree to pay the Internet service provider a fee that may be calculated based on usage or otherwise as described previously.

As another example, a cable or other company that has equipment for providing access to the Internet may provide free access to users to certain domains. A user that does not pay a monthly or other fee for Internet access may still be granted access to these domains. Organizations associated with the domains may pay the cable company a fee for user usage that accesses hosts on their associated domains.

A network access device, redirected Web page, or the like may be used to indicate domains or services that are available for free to a user so that a user may know what services the user may access without paying a fee to an Internet service provider associated with the network access device.

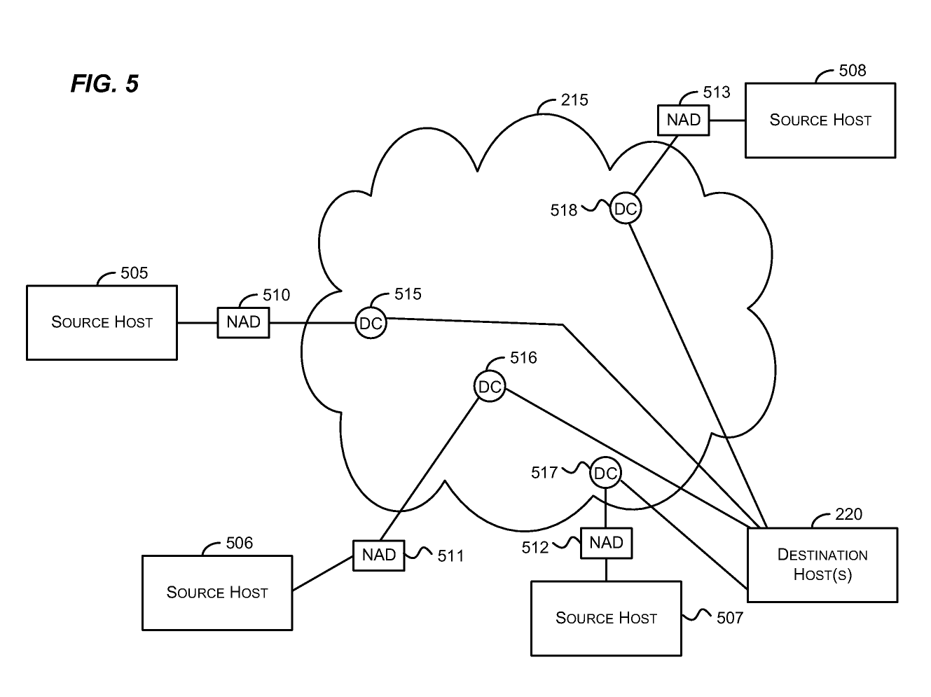

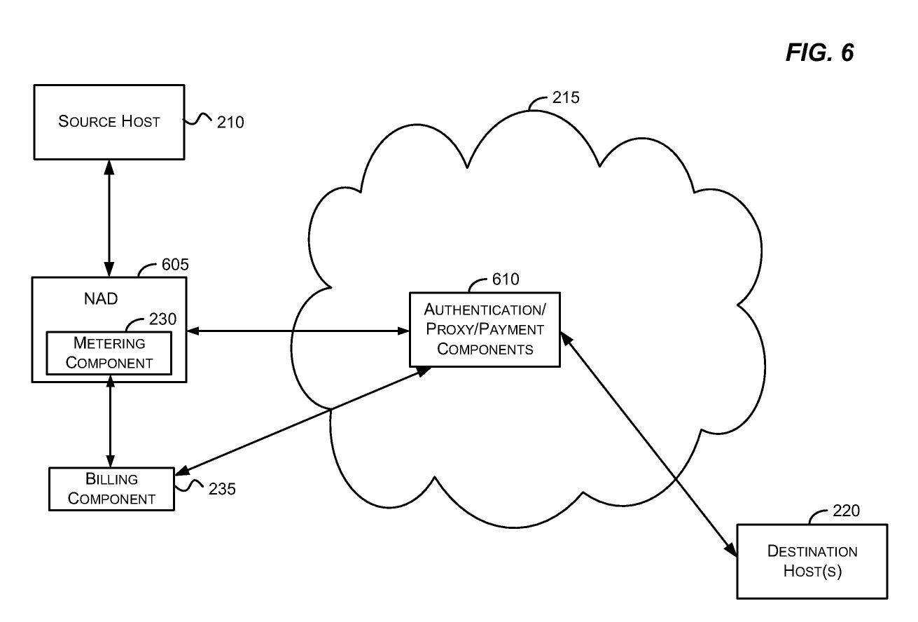

FIGS. 5-6 are block diagrams representing exemplary environments in which aspects of the subject matter described herein may be implemented. Turning to FIG. 5, the environment includes source hosts 505-508, network access devices 510-513, distributed components 515-518, network 215, and destination host(s) 220.

The source hosts 505-508 correspond to the source host 210 of FIG. 2 and may be provided access to the network 215 by an entity that controls the network access devices 510-513. The network access devices 510-513 correspond to the network access devices 225-228 of FIG. 2.

The source hosts 505-508 may be placed at different locations (e.g., different hotels, different stores, etc.) in which the entity provides network access via the network access devices 510-513. Although only one source host is shown connected to each network access device, it is to be understood that there may be more than one source host connected via each network access device.

The distributed components 515-518 may include authentication, metering, proxy, and billing components as those components have been described previously. These components may be included on one device or may be distributed across multiple devices. For communications with the destination host 220, the entity providing access to the network 215 (e.g., via the network access device 510-513) does not need to authenticate, meter, or bill for network access. Instead, the distributed components may perform these functions as previously indicated.

When a source host seeks to access a domain for which “free” access has been provided, the associated network access device may allow the access regardless of whether the source host has paid for or authorized payment for accessing the network 215. As described previously, a DNS server, for example, may determine the distributed components to which to send communications from the source host. This may be determined, for example, based on which distributed components are able to provide low latency to the requesting source host as previously indicated.

Where the network access devices 510-513 are provided by a single entity (e.g., a single company or organization), the billing components of the distributed components 515-518 may combine the measured usage of each of the source hosts 505-513 to the destination host(s) 220 in determining how much to bill. The metering components may omit usage from source hosts that pay for or authorize payment for access to the network 215.

Turning to FIG. 6, the environment includes a source host 210, a network access device 605, a billing component 235, authentication, proxy, and payment components 610, a network 215, and destination host(s) 220. The network access device 605 corresponds to the network access devices 225-228 of FIG. 2 and includes a metering component 230.

The authentication, proxy, and payment components 610 may be included on one device or may be distributed across multiple devices. Furthermore, although only one instance of these components is illustrated in FIG. 6, in other embodiments, there may be multiple instances of these components distributed at various locations throughout the network 215 (e.g., as shown in FIG. 5).

The components 610 may provide authentication services as indicated previously. In addition, these components may serve as a proxy to the source host 210 and allow the source host 210 to access other sites. These components may also include payment components that provide payment in response to a bill from the billing component 235.

In the environment illustrated in FIG. 6, the entity providing network access to the network 215 (e.g., via the network access device 605) may have a metering component 215 and a billing component 235. The entity associated with the components 610 may omit or not use (if included) metering and billing components for communications directed through the network access device 605.

Although the environments described above in conjunction with FIGS. 2, 5, and 6 include various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

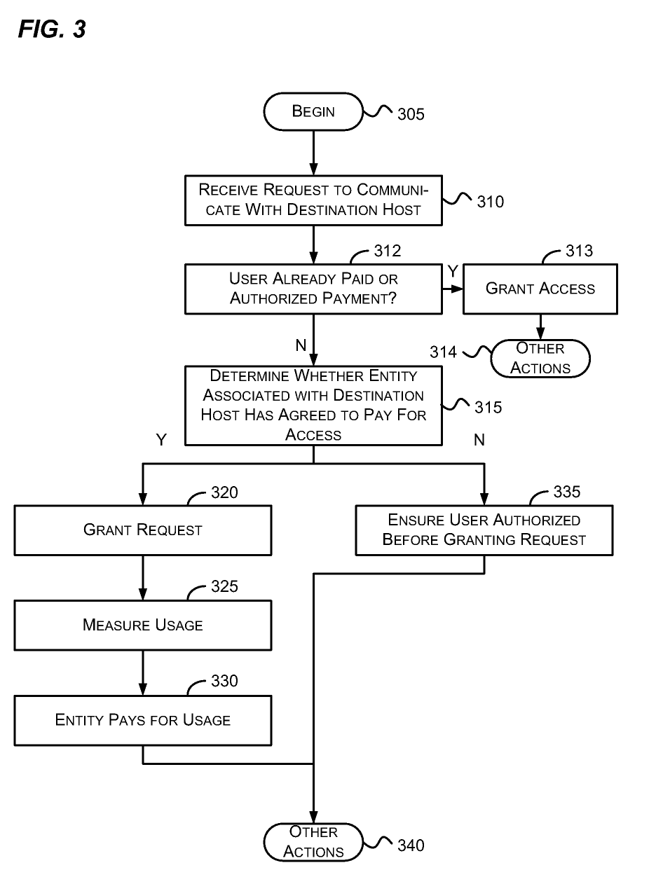

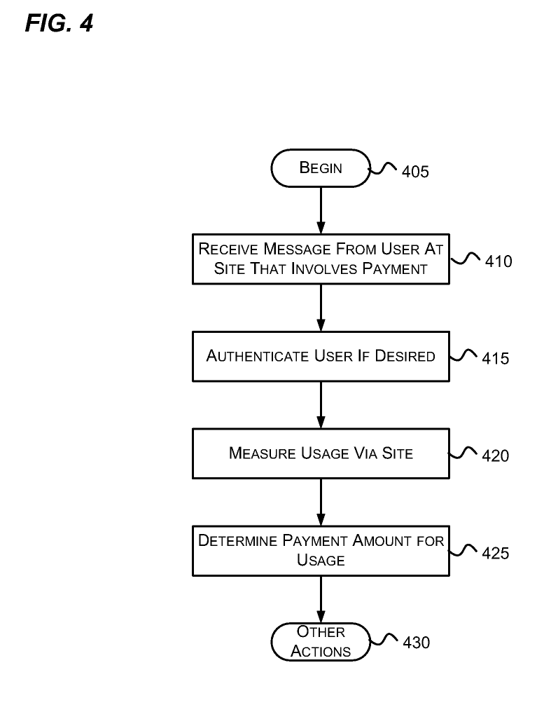

FIGS. 3-4 are flow diagrams that generally represent actions that may occur in accordance with aspects of the subject matter described herein. For simplicity of explanation, the methodology described in conjunction with FIGS. 3-4 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 3, at block 305, the actions begin. At block 310, a request to communicate with a destination host is received. For example, at location 205, the network access device 225 receives a request from the source host 210 to communicate with one of the destination hosts 220.

At block 312, a determination is made as to whether the user has already paid or authorized payment for access to the network. If so, the actions continue at block 313; otherwise, the actions continue at block 315. If the user has already paid or authorized payment for access to the network, there is no need to perform the actions of block 315.

At block 313, access is granted to the network. For example, referring to FIG. 2, if the user of the source host 210 has already paid or authorized payment for access to the network 215 while at location 206, the network access device 226 may grant access without the actions described in conjunction with block 315.

At block 314, other actions, if any, may occur.

At block 315, whether an entity associated with the destination host has agreed to pay for access to the destination host is determined. If so, the actions continue at block 320; otherwise, the actions continue at block 335. For example, referring to FIG. 2, the network access device 225 may use one of the agreement components 240 to determine whether the destination host is associated with an entity that has agreed to pay for access to the destination host. If so, the actions continue at block 320; otherwise, the actions continue at block 335.

At block 320, the request is granted regardless of whether the second entity has paid for or authorized payment for accessing the network. For example, referring to FIG. 2, if an entity associated with the destination host has agreed to pay for the access, the request is granted regardless of whether the user has paid or authorized payment for access to the network 215.

At block 325, usage is measured. For example, referring to FIG. 2, one or more of the metering component(s) 230 measure usage of network access device 225 in providing access to the destination host to the source host 210.

At block 330, the entity pays for the usage. For example, referring to FIG. 2, an entity associated with the destination host (e.g., one of the destination hosts 220) pays for the access provided to the source host 210.

At block 335, ensuring that the user is authorized to access the network is performed before granting request. For example, referring to FIG. 2, the network access device 225 may obtain payment information or otherwise determine that a user is authorized to access the network 215 before granting access to the network 215.

At block 340, other actions, if any may occur.

Turning to FIG. 4, at block 405, the actions begin. At block 410, a message is received at a host from a user who is at a site that involves payment for network access. For example, referring to FIG. 2, one of the destination hosts 220 receives a message from the source host 210 while located at the location 206. The message is routed through the network access device 226 to get to the network 215 and subsequently the destination host 220.

At block 415, the user is authenticated if desired. For example, if the host is part of an enterprise network, the host may authenticate the user before granting the user access to the enterprise network.

At block 420, user network usage via the site is measured. For example, referring to FIG. 2, one or more of the metering components 230 may measure network usage of the user while at the location 206 and using the network access device 226. This network usage information may be used later on (as indicated below) for determining a payment amount for the usage. The network usage information may include network usage of other devices that use one or more of the network access devices 225-228 to access the destination host or any other destination host associated with the entity that has agreed to pay for such use.

At block 425, a payment amount for the usage is determined. For example, referring to FIG. 2, one or more of the billing component 235 uses the measured network usage information to determine an amount to pay for the network usage. As described previously, in one embodiment, payment may be based on sales generated by the network usage.

At block 430, other actions, if any, are performed.

As can be seen from the foregoing detailed description, aspects have been described related to providing simplified network access. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
at a device responsible at least in part for providing and/or denying access to a network, receiving a request to communicate with a host reachable via the network, the device being associated with a first entity, the request being issued by a second entity;
determining whether the host is associated with a third entity that has agreed to pay the first entity for providing access to the host;
if the host is associated with the third entity, granting the request regardless of whether the second entity has paid for or authorized payment for accessing the network; and
if the host is not associated with the third entity, ensuring that the second entity is authorized for access to the network before allowing the second entity to communicate with the host.

2. The method of claim 1, further comprising maintaining a list of domains associated with entities that have agreed to pay for allowing communications with hosts associated with the domains and allowing communications with the hosts via the device regardless of whether the second entity has paid for or authorized payment for accessing the network.

3. The method of claim 1, wherein the request is sent via a wireless network that typically charges a fee for providing access to the network.

4. The method of claim 1, further comprising measuring usage to the host and determining an amount the third entity owes the first entity based thereon.

5. The method of claim 4, wherein measuring usage comprises measuring time that connections are open to the host.

6. The method of claim 4, wherein measuring usage comprises measuring a number of different entities that send messages to the host in a selectable period of time.

7. The method of claim 4, wherein measuring usage comprises determining one or more types of data that are transmitted to and from the host.

8. The method of claim 4, wherein measuring usage comprises determining an amount of data that is transmitted to and from the host.

9. The method of claim 4, wherein measuring usage to the host comprises measuring the usage via one or more components controlled by the third entity.

10. The method of claim 4, wherein measuring usage to the host comprises measuring the usage via one or more components controlled by the first entity.

11. The method of claim 4, wherein measuring usage to the host comprises measuring the usage via one or more components controlled by the first entity and measuring the usage via one or more components controlled by the third entity, and further comprising comparing usage measured via the one or more components controlled by the first entity with usage measured via the one or more components controlled by the third entity to determine an amount the third entity is to pay the first entity.

12. The method of claim 1, wherein the host comprises a search engine and further comprising determining an amount to pay the first entity based on one or more goods and/or services sold to the second entity at least partially as a result of the first entity providing access to the search engine to the second entity.

13. A computer storage medium having computer-executable instructions, which when executed perform actions, comprising:
at a host associated with a third entity, receiving a message issued by a second entity, the message traveling through a first device associated with a first entity, the first device responsible at least in part for providing and/or denying access to a network over which the host is reachable to a second device associated with the second entity;
measuring the second entity's usage of the host via communication by the second device through the first device to the host; and
determining an amount the third entity is to pay the first entity for the usage.

14. The computer storage medium of claim 13, further comprising providing access to the second entity to Internet sites via the host.

15. The computer storage medium of claim 13, further comprising authenticating the second entity and/or second device by the host.

16. The computer storage medium of claim 13, further comprising providing a secure channel between the second device and a business network, the secure channel being provided at least in part via the host.

17. The computer storage medium of claim 13, further comprising determining an amount a fourth entity is to pay to the third entity for the usage, the fourth entity contracting with the third entity to provide user-free network access to entities connecting to a host controlled by the fourth entity from a location that charges for the network access.

18. In a computing environment, a system, comprising:
a network access device operable to provide and/or deny access to a network, the network access device being further operable to receive a request to communicate with a host reachable via the network, the network access device being associated with a first entity, the request being issued by a second entity; and
an agreement component operable to determine whether the host is associated with a third entity that has agreed to pay the first entity for providing access to the host,
wherein the network access device is further operable to grant the request regardless of whether the second entity has paid for or authorized payment for accessing the network if the host is associated with the third entity; and
wherein the network access device is further operable to ensure that the second entity has paid for or authorized payment for access to the network before allowing the second entity to communicate with the host if the host is not associated with an entity that has agreed to pay the first entity for providing access to the host.

19. The system of claim 18, further comprising a metering component operable to measure usage of the network access device where the third entity has agreed to pay the first entity for providing access to the host.

20. The system of claim 18, further comprising a billing component operable to determine an amount owed for use of the network to access the host where the third entity has agreed to pay the first entity for providing access to the host.
